(19) United States
(12) Patent Application Publication
(10) Pub. No.: US 2018/0273369 A1
(43) Pub. Date: Sep. 27, 2018

(54) BEVERAGE FILLING MACHINE FOR FILLING CANS HAVING A HEAT EXCHANGE UNIT SECURED INTERNALLY THEREOF WITH A LIQUID BEVERAGE

(71) Applicant: JOSEPH COMPANY INTERNATIONAL, INC., Irvine, CA (US)

(72) Inventor: MITCHELL J. JOSEPH, Irvine, CA (US)

(73) Assignee: JOSEPH COMPANY INTERNATIONAL, INC., Irvine, CA (US)

(21) Appl. No.: 15/757,231

(22) PCT Filed: Sep. 2, 2016
(86) PCT No.: PCT/US16/50107

§ 371 Date: Mar. 2, 2018

Related U.S. Application Data
(60) Provisional application No. 62/213,711, filed on Sep. 3, 2015.

(51) Int. Cl. B67C 3/26; B67C 3/22; B67C 3/24

(52) U.S. Cl. CPC B67C 3/26; B67C 3/225; B67C 2003/266; B67C 2003/2657; B67C 3/24

(57) ABSTRACT

A rotary beverage filling machine for cans which have a heat exchange unit secured to the bottom thereof and extending into the can which includes a conveyor for transporting cans to be deposited on a pedestal which is adapted to move the can into contact with a sealing device surrounding a nozzle which is disposed within the open upper end of the can but is displaced from the heat exchange unit.

### FIELD OF THE INVENTION

This application relates to a beverage filling machine for filling cans with a liquid beverage and more specifically for filling such cans which have a heat exchange unit secured internally thereof and extending toward the opening of the beverage can.

### BACKGROUND OF THE INVENTION

Beverage filling plants for filling bottles or cans with a liquid beverage filling material are widely known in the prior art and include beverage filling machines of various configurations, many of which include a rotary filling machine with a plurality of beverage filling positions. Each of these positions has a beverage filling device for filling the bottles or cans with the liquid beverage. The filling devices typically include an apparatus designed to introduce a predetermined volume of liquid beverage into the interior of the bottles or cans to a substantially predetermined level. To accomplish this, the filling devices typically include a discharge apparatus which extends internally into the bottle or can sometimes extending essentially to the bottom of the bottle or can so that the liquid beverage enters the can in the proper manner. The liquid beverage is traditionally stored in a vessel under pressure by a gas such as carbon dioxide. The vessel is connected typically to a reservoir or supply of liquid beverage material by a supply line.

After the filling process has been completed, the filled beverage bottles or cans are transported to a closing machine which is typically a rotary closing machine where a cap or lid is applied to the bottle or can, respectively. Once the bottles or cans have been closed appropriately, they are then transported by a conveying arrangement to a position where they may be shipped or stored for later shipment.

As above pointed out, the typical filling machine involves a nozzle or spear type arrangement which is inserted into the container which is to receive the beverage by a substantial distance and the beverage is then dispensed to fill the container. However, when the container is a beverage can, and that beverage can include a heat exchange unit which is secured to it and extends internally into the beverage can, the nozzle or other filling device cannot be extended into the can by any substantial amount. There is therefore needed a filling machine which can accommodate a beverage can which has a heat exchange unit secured internally thereof.

### SUMMARY OF THE INVENTION

The present invention is directed to a filling machine for filling a can with a beverage, the can has a heat exchange unit secured to the bottom of the can and extending internally of the can toward an upper end thereof so as to be surrounded by the beverage when the can is filled with a beverage, the filling machine includes a conveyor for transporting the cans into the filling machine, a plurality of pedestals each of which is adapted to receive a can from the conveyor with the open top thereof facing upward, a beverage dispensing nozzle and a centering cup surrounding the dispensing nozzle with a sealing member disposed within the centering cup, means is provided to move the pedestal upward toward the dispensing nozzle until a can positioned thereon is centered by the centering cup against the sealing member and the dispensing nozzle is disposed within the open upper end of the can but displaced from the heat exchange unit, a reservoir for the beverage and a valve disposed between the reservoir for the beverage and the beverage dispensing nozzle and operable to be opened for a predetermined period of time sufficient to fill the can with the beverage.

### BRIEF DESCRIPTION OF THE DRAWINGS

FIG. 1 is a cut-away perspective view of a beverage can which is to be filled with the filling machine of the present invention;

FIG. 2 is a schematic diagram of a filling plant incorporating the filling machine of the present invention;

FIG. 3 is a perspective view of a filling machine constructed in accordance with the principles of the present invention;

FIG. 4 is a perspective view of the input mechanism for the filling machine of FIG. 3;

FIG. 5 is a perspective view of a pedestal for receiving the beverage can; and

FIG. 6 is a perspective view of the centering cup and nozzle of a filling machine constructed in accordance with the principles of the present invention.

### DETAILED DESCRIPTION OF THE INVENTION

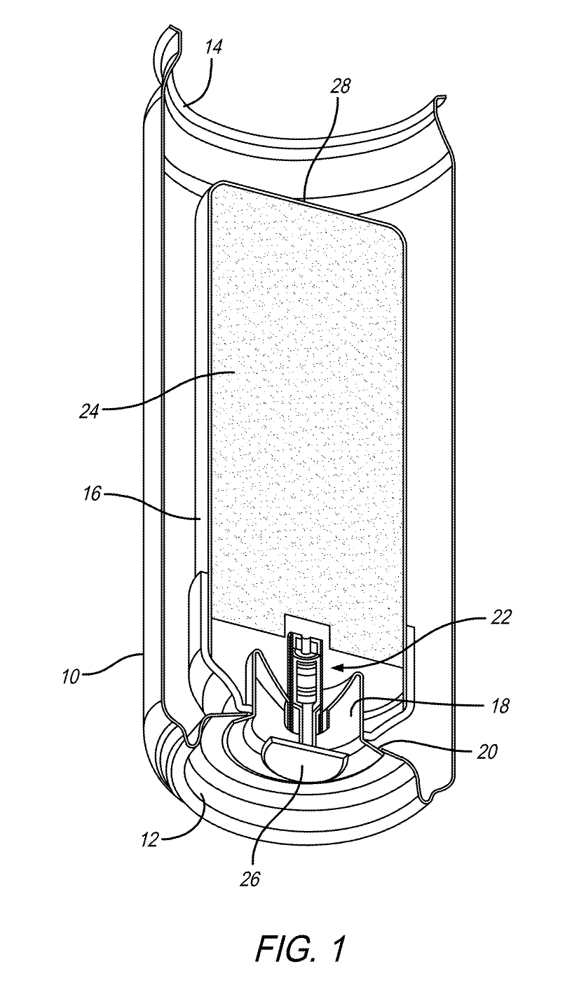

Referring now to the drawings and more specifically to FIG. 1, there is shown in a cut-away perspective view a container which is to be filled with a beverage utilizing the filling machine constructed in accordance with the principles of the present invention. As is illustrated in FIG. 1, the container is a can having a bottom 12 and an open top 14. A heat exchange unit 16 is affixed to the bottom 12 of the can 10 through the utilization of a valve cup 18 which is secured to an opening 20 that is provided in the bottom 12 of the can 10. An appropriate valve mechanism 22 is secured to the valve cup 18 and is utilized to charge the heat exchange unit with an appropriate material that when activated will provide either an endothermic reaction to cool a beverage within the container within the can 10 or an exothermic reaction to heat the beverage within the can 10. Illustrated at 24 within the heat exchange unit 16 is an appropriate material to provide the desired endothermic or exothermic reaction. Such materials are well known to those skilled in the art and may include carbon dioxide for the endothermic reaction and a calcium carbide water combination for the exothermic reaction. An appropriate activating mechanism such as a push button 26 is utilized so that the customer, when such is desired, may either heat or cool the beverage by activating the valve 22 by depressing the activating button 26. To fill the can 10 with an appropriate beverage, the open upper end 14 is positioned within the filling machine so that a nozzle which was utilized to discharge the beverage is positioned within the can but displaced from the end 28 of the heat exchange unit 16 and the beverage is then dispensed within the container and will flow around the outer surface of the heat exchange unit 16 until the can is filled. Thereafter, an appropriate lid is affixed to the open upper end 14 of the can 10 by appropriate sealing and gripping as is well known in the art.

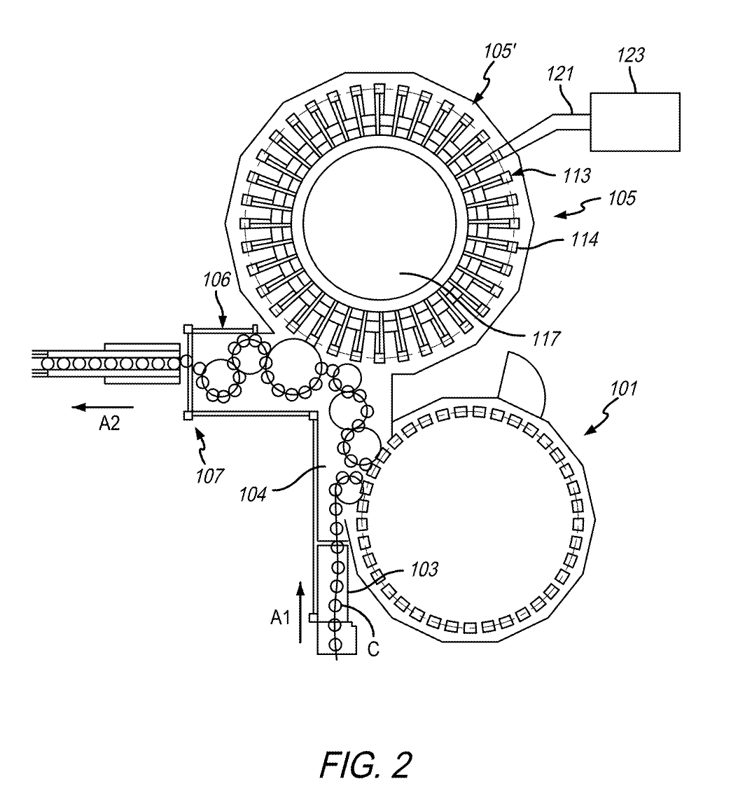

Referring now more particularly to FIG. 2, there is illustrated therein in schematic form a portion of a filling plant for filling cans with a beverage and which includes a filling machine constructed in accordance with the principles of the present invention. As is shown in FIG. 2, there is provided a rinsing station 101 to which the cans C are fed in the direction of travel as indicated by the arrow A1 by a first conveyor arrangement 103. The conveyor arrangement 103 can be a linear conveyor or a combination of a linear conveyor and a star wheel as is well known in the art. Downstream of the rinsing station 101 in the direction of travel as indicated by the arrow A1, the rinsed cans C are transported to a beverage filling machine 105 by a second conveyor arrangement 104 that is formed for example by one or more star wheels that introduce cans C into the beverage filling machine 105.

The beverage filling machine 105 is of a revolving or rotary design with a rotor 105′ which revolves around a central vertical axis. The rotor 105′ is designed to receive and hold the cans C for filling at a plurality of filling positions 113 located about the periphery of the rotor 105′. At each of the filling positions 113 is located a filling arrangement 114 having at least one filling device, element, apparatus, or valve. The filling arrangements 114 are designed to introduce a predetermined volume of liquid beverage into the interior of the cans C to a predetermined level required to fill the can. The filling arrangements 114 receive the liquid beverage material from an annular vessel 117 in which a supply of the liquid beverage material is stored under pressure by a gas such as carbon dioxide. The annular vessel 117 is a component for example of the revolving rotor 105′. The annular vessel 117 can be connected by means of a rotary coupling or a coupling that permits rotation. The annular vessel 117 is also connected to at least one external supply of liquid beverage material 123 by a conduit or supply line 121.

Downstream of the beverage filling machine 105 in the direction of travel of the cans C there can be a beverage can closing arrangement or closing station 106 which closes or applies a cap to the open top of the cans C after the cans have been filled with a beverage at the beverage filling machine 105. The beverage can closing station 106 is connected by a third conveyor arrangement 107 to a storage or holding area for shipment as may be desired to a particular customer or stored in a storage area for subsequent shipping as needed. The third conveyor 107 may be formed for example by a plurality of star wheels as illustrated or may also include a linear conveyor device which will transport the filled and closed beverage cans in the direction as shown by the arrow A2.

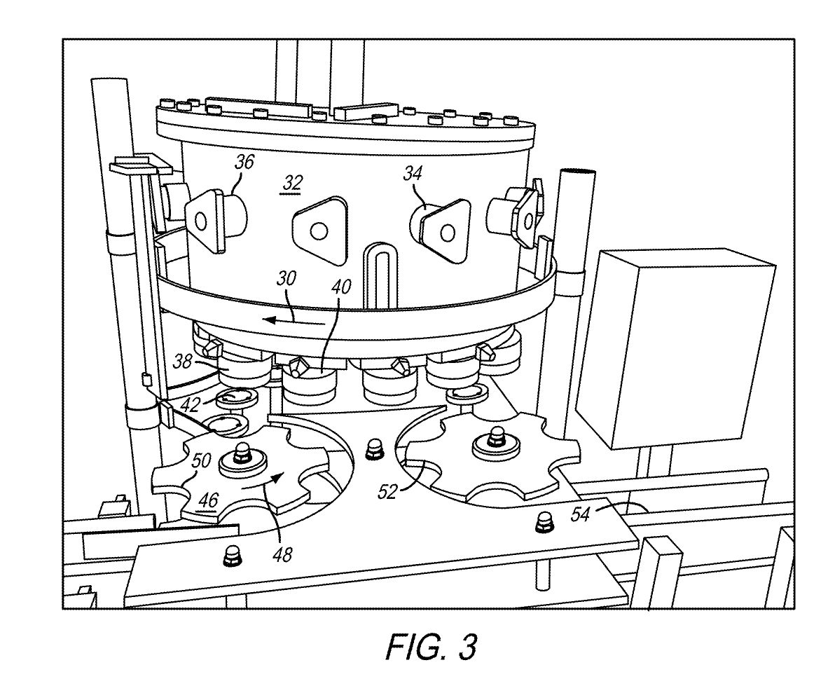

Referring now more specifically to FIG. 3, there is illustrated therein a filling machine constructed in accordance with the principles of the present invention. As is illustrated in FIG. 3, the filling machine is a rotary apparatus which rotates in the clockwise direction as shown by the arrow 30. The apparatus includes an annular tank 32 which is rotatably supported on an axis (not illustrated). The annular tank 32 contains the beverage material which is to be dispensed into the cans when they arrive at the filling station to be filled by the filling machine as shown in FIG. 3. As above described with the schematic of FIG. 2, the annular tank 32 is connected by an appropriate conduit to a source of the beverage and the beverage is pump fed from that source (not shown in FIG. 3) to the annular tank 32. The beverage is maintained within the tank 32 under pressure from a gas such as carbon dioxide at a relatively low pressure.

A plurality of valves such as those shown at 34 and 36 are disposed to open and close and provide beverage contained within the annular tank 32 to a dispensing nozzle which is disposed within a centering cup as shown at 38 and 40 and which will be described in greater detail below. Disposed immediately beneath the centering cups is a pedestal as shown at 42. There will be a pedestal for each of the centering cups that are disposed peripherally around the filling machine.

A linear conveyor mechanism 44 transports the cans with the open upper end thereof facing upwardly as shown in FIG. 3. The cans move along the conveyor mechanism 44 toward a star wheel 46 which rotates in a direction shown by the arrow 48. Each of the cans when they meet the star wheel 46 are picked up by the depressions shown in the star wheel such as that at 50 and transported to be situated on a pedestal such as that shown at 42. As a result there will be one can on each of the pedestals and each of the cans is then positioned directly below a centering cup such as is shown at 38. When the can is positioned on the pedestal 42, it activates a switch which will then cause the pedestal 42 to be elevated upwardly toward the centering cup such as that shown at 38 and will then be positioned such that the appropriate valve associated with that centering cup and pedestal will open to discharge beverage from the annular tank 32 through the appropriate valve such as 36 into the can. The can then rotates along with the pedestal, the valves and the annular tank for a period of time with the valve being open so that a predetermined amount of beverage is discharged into the can thereby filling it so that the beverage is then surrounding the heat exchange unit contained within the can. When the can is filled with the beverage, it then is removed from the filling machine as shown in FIG. 3 by the star wheel 52 and deposited on the linear conveyor 54 to be conveyed to the station where the cap or lid for the can is affixed to the open upper end thereof.

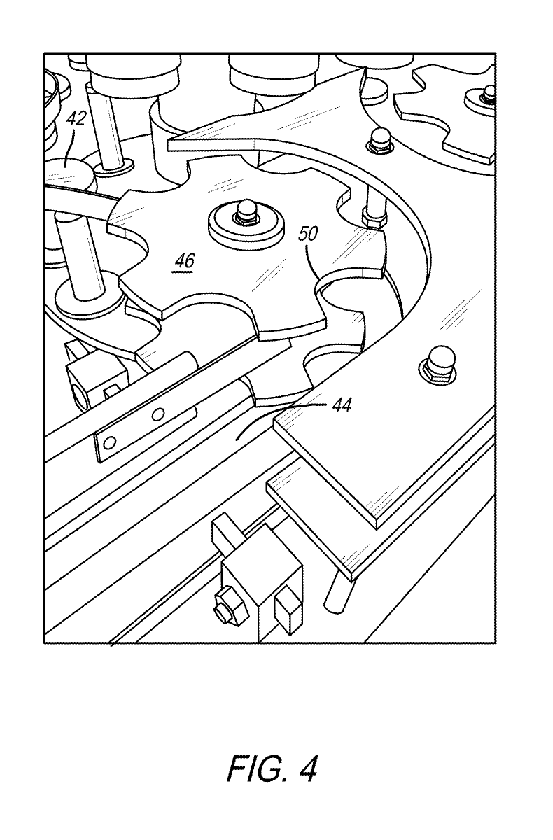

By reference now to FIG. 4 there is illustrated in perspective view in greater detail the star wheel 46 with the depressions 50 therein for receiving the cans as they are transported along the linear conveyor 44 to the filling machine to be deposited on the pedestal 42 as above described.

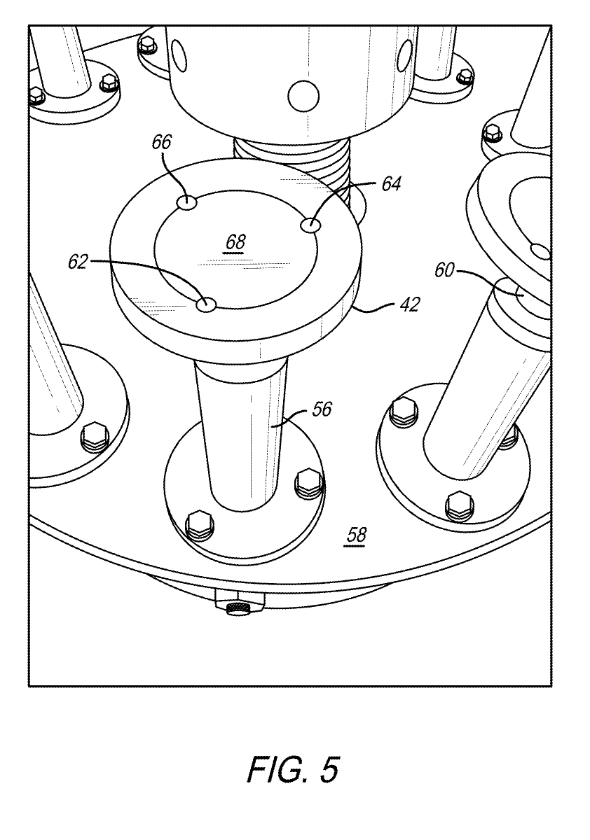

Referring now more particularly to FIG. 5, the pedestal such as that shown at 42 is illustrated in greater detail. As is therein shown, the pedestal 42 is disposed upon a support member 56 which is affixed to a rotary table 58 which is an integral portion of the filling machine as illustrated in FIG. 3. The pedestal 42 is supported upon a reciprocal member 60 which is contained within the support member 56 and reciprocates up and down in response to a cam mechanism disposed below the table 58 (not shown in FIG. 5). As the member 60 reciprocates, it moves the pedestal 42 upwardly so that a can situated on the pedestal 42 engages the centering cup disposed immediately above the pedestal 42.

In order to support a can which is disposed upon the surface 68 of the pedestal 42, a plurality of magnets 62, 64 and 66 are embedded into the surface 68 of the pedestal 42. As a result, when the can is placed upon the pedestal 42 by the operation of the star wheel 46, it is gripped by the magnets 62, 64 and 66 and retained firmly in place during manipulation of the can to move it upwardly into engagement with the centering member for filling with the beverage as above described.

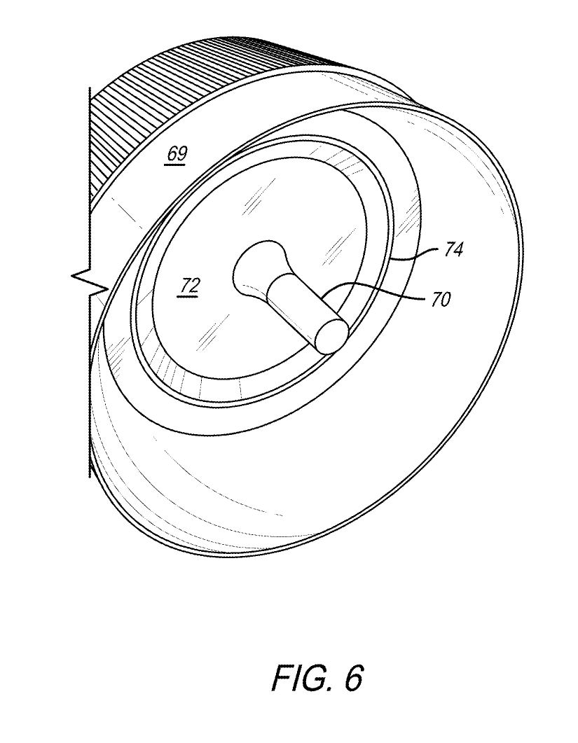

Referring now more particularly to FIG. 6, there is illustrated the centering cup 69 which has centrally disposed therein a discharge nozzle 70. The discharge nozzle 70 is associated with an appropriate valve that when opened allows the beverage contained within the annular tank 32 to flow under slight pressure from the carbon dioxide contained therein through the nozzle 70 and into the can for a predetermined period of time in order to fill the can with the desired amount of beverage. Surrounding the nozzle 70 is a sealing material 72 which has a groove 74 formed therein. When the can is transported upwardly by the pedestal, through the upward movement of the reciprocal element 60, the open edge of the can engages the groove 74 and effects a seal around the can. As a result of the seal, the beverage being discharged through the nozzle 70 is maintained within the interior of the can and does not spill outwardly therefrom. When the can has been appropriately filled with a beverage flowing through the nozzle 70, it is then lowered by the lowering of the pedestal 42 and the can is transported to be removed from the filling machine by the exit star wheel 52 and transported to the closing station for a cap to be secured to the open upper end of the can.

There has thus been disclosed a filling machine for filling a can with a beverage with a can having a heat exchange unit affixed internally thereof and extending toward the open upper end of the can.

What is claimed is:

1. A filling machine for filling a can with a beverage, the can having a heat exchange unit secured to the bottom of the can and extending internally of the can toward an open upper end thereof so as to be surrounded by the beverage when the can is filled with the beverage, the filling machine comprising:
a conveyor for transporting the cans into the filling machine;
a plurality of pedestals thereon, each pedestal adapted to receive a can from the conveyor with the open top thereof facing upward;
a beverage dispensing nozzle;
a centering cup surrounding said dispensing nozzle;
a sealing member disposed within said centering cup;
means for moving each pedestal upward toward said dispensing nozzle until a can positioned thereon is centered by the centering cup against the sealing member and the dispensing nozzle is disposed within said open upper end but displaced from the heat exchange unit;
a reservoir for the beverage;
a conduit connected between the reservoir and the dispensing nozzle for conducting the beverage from the reservoir to the dispensing nozzle; and
a valve disposed between the conduit and the dispensing nozzle and operable to be opened for a predetermined period of time sufficient to fill the can with the beverage.

2. A filling machine as defined in claim 1 wherein each pedestal has a flat surface for receiving a can and said flat surface includes a plurality of magnets embedded therein to hold said can in place.

3. A filling machine as defined in claim 1 wherein means for moving each pedestal includes a reciprocal member upon which the pedestal is mounted.

4. A filling machine as defined in claim 1 wherein said sealing member defines a groove therein and said upper end of said can seats in said grove.

5. A filling machine as defined in claim 1 wherein said predetermined period of time for said nozzle to be opened is initiated by a can being positioned upon a pedestal.
